(19) United States
(12) Patent Application Publication
(10) Pub. No.: US 2005/0220266 A1
(43) Pub. Date: Oct. 6, 2005

(54) Methods for achieving high resolution microfluoroscopy

(76) Inventor: Gregory Hirsch, Pacifica, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/095,085

(22) Filed: Mar. 30, 2005

Related U.S. Application Data
(60) Provisional application No. 60/558,394, filed on Mar. 31, 2004.

(51) Int. Cl. G21K 7/00

(52) U.S. Cl. 378/43

(57) ABSTRACT

A microfluoroscope has a source of soft x-rays and a solid immersion lens including a plano surface. There is means for placing a sample in close proximity to the plano surface so that an x-ray absorption shadowgraph of the sample is projected onto the plano surface by the source of soft x-rays. A scintillator on the solid immersion lens plano surface produces fluorescent light from soft x-rays passing through the sample. An optical microscope is used for viewing through the solid immersion lens the fluorescent light from the scintillator corresponding to the x-ray absorption shadowgraph of the sample. A microfluoroscope is also disclosed which includes a source of soft x-rays, a fluorescent screen placed at a plane to receive x-rays and means for placing a sample in close proximity to the plane so that an x-ray absorption shadowgraph of the sample is projected onto the fluorescent screen. A nanochannel mask placed between the fluorescent screen and the sample for limiting x-rays reaching the fluorescent screen to a periodic matrix of nanochanneled beams. A computer system combines all the discrete images at each raster position into a composite image representing the x-ray absorption shadowgraph of the entire sample.

### CROSS-REFERENCES TO RELATED APPLICATIONS

This application claims the benefit of Provisional Patent Application 60/558,394 filed Mar. 31, 2004 entitled “Methods for Achieving Extremely High Resolution Microfluoroscopy.”

### GOVERNMENT RIGHTS IN THE INVENTION

This invention was made under government support under Grant R44 GM62067 awarded by the National Institute of General Medical Sciences/National Institutes of Health. The United States Government as represented by the Secretary of Health and Human Services has certain rights in this invention

### REFERENCE TO A “SEQUENCE LISTING,” A TABLE, OR A COMPUTER PROGRAM LISTING APPENDIX SUBMITTED ON A COMPACT DISK.

NOT APPLICABLE

The subject of this invention involves microfluoroscopy. More particularly, several methods aimed at achieving the highest possible spatial resolution in soft x-ray microfluoroscopy are disclosed. Although these methods could be applied to several different microfluoroscope configurations and types of objects examined, this invention is particularly concerned with their use with an instrument designed for biological microscopy that is referred to as a Laser-Plasma Microfluoroscope (LPM). That technology is the subject of U.S. Pat. No. 5,912,939 “Soft X-ray Microfluoroscope” (1999).

The LPM is essentially a miniaturized fluoroscope that uses long-wavelength x-rays to image individual biological cells and other thin specimens. Samples are placed in direct contact with a fluorescent screen (scintillator) and illuminated with pulses of soft x-rays radiated by an extremely hot laser-produced plasma. The resulting unmagnified luminescent shadowgraph of the sample is viewed in real-time using light microscopy. The technology can be thought of as a hybrid of light microscopy and soft x-ray microscopy. The method produces images having extremely high depth-of-field, with three-dimensional information of overlapping features accessible using stereoscopic imaging methods. Key advantages of the instrument's design are its relatively low-cost, very compact size, and the ability to be used as an accessory device with standard light microscopes. Thus, it is not necessary to have a separate dedicated soft x-ray microscope. The instrument has the capacity to rapidly switch imaging modes between light microscopy and soft x-ray microfluoroscopy without requiring changes to the sample environment.

The preceding by no means implies that this invention is only applicable to the viewing of biological samples. Other types of organic and inorganic objects can also be examined. The technique is especially valuable for thin objects that are opaque to light such as semiconductor devices. In addition, all types of x-ray sources are covered under the scope of this patent. The use of biological samples and laser-plasma sources is just one obvious and important use of this invention. This invention encompasses all fluoroscopic methods that rely on the high-resolution methods disclosed herein.

### BACKGROUND OF THE INVENTION

Two techniques dominate biological microscopy today: light (optical) microscopy and electron microscopy. While light microscopy is an ideal tool in most respects, its utility is constrained by its limited spatial resolution. This has driven the development of higher-resolution forms of microscopy, of which electron microscopy is the most important. Electron microscopy, while stunningly successful in elucidating cell ultrastructure, has its own limitations. As most commonly practiced, specimens must be fixed, stained, sectioned, and, due to the vacuum environment, dehydrated.

One way the limitations of both light and electron microscopy are being addressed is by using soft x-ray photons for microimaging. Optical microscopy was extended from visible light into the ultraviolet range some 100 years ago to obtain improved resolution and contrast. It is reasonable to think of x-ray microscopy as the logical continuation of this effort. Microscopy using soft x-rays has the ability to produce high-resolution images of biological materials in their natural state. Although not a panacea, soft x-ray microscopy has the potential to fill an important niche in biological microscopy: the suboptical-resolution imaging of unsectioned, hydrated specimens. By using x-rays with a wavelength between the K-edges of oxygen and carbon (≈2.3-4.4 nm), high contrast can be obtained without staining. This is termed the “water window” due to the relative transparency of water compared to organic material. Phase contrast methods have also been used outside of this range for achieving high contrast in native samples.

Several different approaches to x-ray microscopy have been developed. Although most of these methods require sophisticated x-ray optics, the simplest method is an optics-free technique known as contact x-ray microscopy, or simply microradiography. As most commonly put into practice, a sample is placed directly onto an x-ray sensitive photoresist and exposed to soft x-rays. The sample is then removed and the photoresist developed. The result is a relief pattern on the photoresist surface, corresponding to the varying x-ray transmission through the sample. The developed resist is usually examined by electron microscopy or atomic force microscopy (AFM). In earlier work, resolution near 10 nm was claimed using this method with very thin samples. A more realistic figure is now believed to be several tens of nanometers. The contact technique suffers from saturation and nonlinear response in the photoresist. The fidelity of the microscopy readout is critical, as is the development and preparation of the photoresist. This technique has been demonstrated with synchrotron radiation, as well as with small laboratory x-ray sources. Obviously, the method is not real-time due to the separate exposure and development steps.

A variation of contact microscopy is to place the sample on a thin, self-supporting membrane. The contact image produces photoemission from the back surface of the membrane, which is in a vacuum. The emitted photoelectrons are accelerated by a high voltage, and imaged at high magnification using electron optics. One thereby obtains a real-time contact image, allowing dynamic viewing of a specimen. These instruments are very complex due to the elaborate electron optics that are required, and have not yet produced images with a resolution better than light microscopy.

The Microfluoroscope

The general subject matter of this invention, the microfluoroscope, is a device that dates to publications in the 1940's and 1950's. The microfluoroscope is, in essence, identical in principle to the common medical fluoroscope. The device is simply a fluoroscope in which a small fluorescent screen is viewed with an optical microscope, thereby allowing the observation of specimen features too small to be seen with the naked eye. The microfluoroscope requires the use of extremely fine-grained or preferably grainless screens to prevent the image from being dominated by the structure of the phosphor itself. The phosphor layer thickness and/or the attenuation length of the x-rays are preferably very small, so that the light-emitting layer is completely within the depth-of-field of the optical microscope. With photons in the water-window range, the attenuation lengths are often less than 200 nm in typical screen materials. Single-crystal scintillators are very good screens due to their homogeneity. Samples can be placed in direct contact with the phosphor. The screen is very thin, permitting the close approach of an optical microscope's objective lens from the non-specimen side for viewing. It can be seen that microfluoroscopy is simply a third type of contact x-ray microscopy that uses a fluorescent media as the detector, rather than a photoresist or photoemissive membrane.

The resolution of any contact microscopy method is limited by Fresnel diffraction in the contact image. This resolution is given by:
δ≈(λd)^{1/2}
where λ is the wavelength of the radiation and d is the separation distance between the feature being imaged and the recording surface. For example, using 2.5 nm radiation (≈500 eV), features 1 μm from the photoresist surface will be recorded at a limiting resolution of ≈50 nm. This assumes that the radiation source is effectively a point, so there is no additional penumbral blurring from a finite source size. Penumbral blurring is generally insignificant with microfocus tubes, or with the plasma sources that will be described below.

Besides Fresnel diffraction, the resolution of a microfluoroscope is obviously constrained by the optics used to view the luminescent image. The resolution of the microfluoroscope is limited by the diffraction constraints of the objective lens used to view the image. The point-to-point resolution of any microscope as originally formulated by Ernst Abbe is:
δ≈0.5λ/NA
where NA is the numerical aperture of the microscope objective lens.

In previous microfluoroscopy experiments, x-rays were generated using a microfocus x-ray tube. Unfortunately, such electron impact sources produce very low intensity in the soft x-ray range. This leads to extremely long exposure times. Fortunately, much higher-intensity sources have been developed. The greatest average power levels are found in synchrotron radiation. While synchrotron radiation is an ideal for soft x-ray microscopy, it is obviously not suitable for general use in small laboratories. Fortunately, other bright sources that are compact and relatively inexpensive have been developed using the x-ray emission from very hot plasmas. Several different methods for generating these hot plasmas have been developed. The most widely used sources now use plasmas created by illuminating targets with the very high power-densities found in the focused beam of pulsed lasers. In comparison to other plasma sources, laser-plasma devices are less costly; more compact; and have much higher repetition rates. In addition, the plasma-volume is smaller and more stable in position. While synchrotron radiation has the highest average power of any x-ray source, plasma sources have a much higher peak-power. For x-ray microscopy applications, this can sometimes allow an image to be recorded with a single shot of the source. Since the pulse duration is extremely short, any motion of the sample due to specimen motility, Brownian motion, or radiation damage will be frozen. There have been a number of demonstrations of single shot x-ray microscopy.

The target in a laser-plasma source is usually a solid surface, but liquid and gas targets have been used. The required power density on the target is dependent on what photon energy range is desired. For producing x-rays in the water window range, a target irradiance of 10¹²-10¹³ W/cm² is optimal. This power density produces a plasma with a temperature of ≈10⁶ K. A common choice for the laser is a Q-switched Nd:YAG laser. With a typical mid-size laser having a pulse width of 5 nsec and pulse energy of 0.5 Joules, the peak power is ≈100 MW. To achieve 10¹² W/cm², a focal spot diameter of ≈110 μm is required. This is very easily achieved with a single mode laser and a simple focusing lens. The output of the laser can be reduced from the above parameters by using a smaller focal spot. For example, a target irradiance of 10¹² W/cm² can be achieved with a 5 nsec laser pulse of 20 mJ if the focal spot is reduced to 23 microns. Such lasers are compact and relatively inexpensive.

By combining the original idea of the microfluoroscope with the use of modem plasma-sources of x-rays, one arrives at the concept of the Laser Plasma Microfluoroscope (LPM). This device is similar to the original microfluoroscope except it employs a laser-produced plasma as a source of soft x-rays instead of a microfocus tube. A miniaturized laser-plasma source can be constructed that allows easy interface with standard light microscopes for microflouroscopic imaging. In addition to microfluoroscopy, other standard techniques such as phase contrast, fluorescence, interference, or confocal microscopy can be used for viewing the same sample.

Radiation damage is a concern in all x-ray microscopy methods. Two approaches to alleviating this problem have been previously studied by investigators. The first is to use intense pulsed sources to acquire the complete image before radiation damage causes noticeable degradation to the sample. Using plasma sources, contact microscopy images have been recorded with exposure times of only a few nanoseconds. The other tactic is to use low-temperature techniques to image frozen samples. Results from both x-ray and electron microscopy have shown this to be an extremely fruitful approach. With the typical dosages required to achieve adequate signal-to-noise with high-resolution x-ray microscopy, no apparent damage is observed in frozen-hydrated samples. The use of low temperature methods is a practical option for addressing radiation damage issues with microfluoroscopy. A big advantage of examining frozen-hydrated or freeze-dried samples is that it allows one to collect images using a number of relatively low intensity x-ray pulses, and thereby design an instrument using a very small and low-cost laser. Compact lasers allow the instrument to be a small accessory device that can easily be placed on a lab bench next to the microscope and conveniently readily moved to other locations.

### SUMMARY OF THE INVENTION

A microfluoroscope has a source of soft x-rays and a solid immersion lens including a plano surface. There is means for placing a sample in close proximity to the plano surface so that an x-ray absorption shadowgraph of the sample is projected onto the plano surface by the source of soft x-rays. A scintillator on the solid immersion lens plano surface produces fluorescent light from soft x-rays passing through the sample. An optical microscope is used for viewing through the solid immersion lens the fluorescent light from the scintillator corresponding to the x-ray absorption shadowgraph of the sample.

A resolution slightly below 150 nm is possible with a microfluoroscope using an oil immersion objective (NA=1.4) and a fluorescent screen with an emission wavelength at the lower end of the visible range. The technology disclosed here using extremely high NA solid immersion lenses is directed at improving the resolution to routinely below 100 nm, and possibly below 50 nm for sample features very close to the scintillator surface. This would be unprecedented for any far-field light microscope.

A microfluoroscope is also disclosed which includes a source of soft x-rays, a fluorescent screen placed at a plane to receive x-rays and means for placing a sample in close proximity to the plane so that an x-ray absorption shadowgraph of the sample is projected onto the fluorescent screen. A nanochannel mask placed between the fluorescent screen and the sample for limiting x-rays reaching the fluorescent screen to a periodic matrix of nanochanneled beams. There is included means to raster scan the sample over the nanochannel mask. A optical microscope for viewing the fluorescent light emitted by the fluorescent screen is utilized that corresponds to the locations of the nanochanneled beams. A camera is utilized to collect the fluorescent image of the nanochanneled beams impinging on the fluorescent screen at each raster location as discrete images. Finally, a computer system combines all the discrete images at each raster position into a composite image representing the x-ray absorption shadowgraph of the entire sample. An alternate version has the nanochannel mask placed before the sample and screen. In this case, the mask rather than sample is scanned to form an image in a similar manner.

From the above, it will be seen that two approaches are possible. One of these approaches tackles the Abbe limit head on by striving to achieve an NA of greater than 2.0, and extending the wavelength into the ultraviolet range. The other approach uses a scanning method that actually circumvents the standard diffraction limit. Both of these approaches are uniquely suited to being applied in microfluoroscopy. Moreover, the two methods may be found to be most productive when used in combination.

### BRIEF DESCRIPTION OF THE DRAWINGS

FIG. 1A illustrates the experimental arrangement for operating a laser-plasma microfluoroscope in conjunction with a hemispherical solid immersion lens. The inverted optical-microscope configuration is shown.

FIG. 1B illustrates the light path in an aplanat solid-immersion-lens.

FIG. 1C illustrates the light path in a catadioptric solid-immersion-lens.

FIG. 2 illustrates a similar arrangement as shown in FIG. 1, except the solid-immersion-lens is constructed from two pieces that can be slid with respect to each other.

FIG. 3 illustrates the sample/scintillator region of a microfluoroscope that is being used with a nanochannel mask collimator located between the sample and the scintillator.

FIG. 4 illustrates the sample/scintillator region of a microfluoroscope that is being used with a nanochannel mask collimator located between the x-ray source and the sample.

FIG. 5 illustrates a nanochannel mask having a square channel-geometry, which employs scanning in two axes.

FIG. 6 illustrates a nanochannel mask having a hexagonal channel-geometry, which employs scanning in two axes.

FIG. 7 illustrates a nanochannel mask having a square channel-geometry, which employs scanning in one axis.

FIG. 8 illustrates a nanochannel mask having hexagonal channel-geometry, which employs scanning in one axis.

### DESCRIPTION OF THE PREFERRED EMBODIMENTS

Two potential methods to push the resolution limit of the current instrument into the range of 0.1 μm and below are disclosed here.
1) Recently developed Solid Immersion Lens (SIL) technology is introduced into the light microscope's optics. Such lenses achieve an extremely high Numerical-Aperture (NA), permitting maximum resolution. In parallel with realizing the highest possible NA, the shortest practical emission wavelength for the fluoroscopic medium can also be used to attain the highest resolution. The solid immersion lens functions both as a high-resolution optical element, and as the scintillator of the microfluoroscope.
2) A scanning method is incorporated into the microfluoroscope to greatly improve the resolution. This approach relies on the use of an innovative nanochannel mask. The scanning procedure permits a resolution that is several times smaller than obtainable with any far-field optical microscope. This scanning method may also be found advantageous when used in combination with the SIL technology. Two basic geometries are disclosed. In the first case, the nanochannel mask resides between the sample and the scintillator, and the sample is scanned over the stationary mask and scintillator. In the second case, the nanochannel mask resides between the x-ray source and the sample, and the mask is scanned over the stationary sample and scintillator.

A microfluoroscope employing a small laser-plasma radiation source is described here as a preferred embodiment. However, this by no means implies that the high-resolution methods described herein are limited to use with such sources. Other radiation sources such as x-ray tubes, synchrotron radiation, and alternate types of plasma sources are also included within the scope of this invention.

Microfluoroscope with Solid Immersion Lens

The first technology discussed for achieving extremely high resolution with microfluoroscopy is the Solid Immersion Lens (SIL). The SIL is a recently developed optical element that has demonstrated the capacity to achieve a significantly higher NA than is feasible with any liquid immersion-objective. The NA of an objective is:
n·sin θ
where n is the refractive index of the medium filling the object space between the sample and the front surface of the objective, and θ is the half-angle of the light cone collected by the objective.

Dry objectives are limited to an NA of 0.95 due to air's near unity refractive index. Water and oil immersion objectives are limited to NA near 1.2 and 1.4 respectively. The highest NA objective commercially available has 1.65 NA. Such objectives are used in Total-Internal-Reflection (TIRF) Microscopy. The refractive index (n_{D}=1.78) of the immersion fluid used with these objectives is the highest of any known liquid that is both chemically stable and transparent throughout most of the visible spectrum. A few liquids have slightly higher indices, but they are chemically very reactive, highly toxic, and are only transparent in the red end of the visible spectrum. One interesting exception is white phosphorus, which readily supercools to a liquid at room temperature. It has a refractive index of over 2.0, and is transparent throughout the visible, and into the near UV range. Unfortunately, it is highly toxic and very chemically reactive.

Many solids have much higher refractive indices than any liquid, which the SIL relies on to achieve its very high NA. There are several different configurations for an SIL. The simplest is the single-piece hemispherical SIL. The hemispherical SIL is a nearly perfect plano-convex hemispherical lens that is fabricated from a material having a very high refractive index. The object being viewed is located directly on the plano-surface of the lens. The SIL is used in combination with a normal dry objective lens, which views the object through the hemispherical surface of the SIL. Long-working-distance (LWD) objectives are advantageous for this application. With this optical arrangement, light that originates at (or is directed towards) the center of the SIL plano-surface encounters the SIL convex surface at normal incidence. Thus, there is no refraction of light as it passes through the SIL/air interface. As a result, larger-angle components of the light cone (corresponding to high NA) are not lost by total internal reflection.

The NA of an SIL objective is simply the product of the refractive index of the lens material, and the NA of the dry objective being used with it. For example, an objective with an NA of 0.8 that is viewing an object through an SIL with n=2.5 will have an effective NA of 2.0. The SIL is sometimes also referred to as a “Numerical Aperture Increasing Lens.” A simple way to think about the SIL is to regard it as a convenient method for reducing the wavelength of light being used with the dry objective to a smaller “adjusted wavelength” of λ_{vac}/n_{SIL}. It must be appreciated that the high NA of an SIL is only realized for objects within a fraction of a wavelength of the lens' plano-surface. This is most easily understood by considering a microscope in which a laser beam is focused onto a sample. Due to total internal reflection, the high-NA rays that reach the plano-surface of the SIL at an angle greater than the critical angle for total internal reflection are reflected back from the interface. However, if the object being studied is within the exponential decay length of the evanescent field existing just beyond the surface, this field can interact with the object, and a high numerical aperture can be realized. Microscopy using an SIL is sometimes referred to as “Photon Tunneling Microscopy” to emphasize that non-propagating evanescent waves are used. Microfluoroscopy has the unique feature of using x-rays to transfer high-resolution information of specimen features at relatively large distances directly to the SIL surface. This permits the full NA of the SIL to be realized, even when features are located much further from the lens surface than the evanescent-wave penetration depth. In effect, the working distance of evanescent-wave microscopy is greatly extended by microfluoroscopy. The SIL has some similarity to NSOM, which also employs evanescent waves to obtain high-resolution information that is not accessible in the far-field.

The SIL can be applied to microflouroscopy by simply fabricating a lens out of a highly refractive scintillator. Alternately, a scintillator or phosphor film can be deposited onto the surface of a non-scintillating SIL. This second option is more complex, since the deposited layer will invariably have a different refractive index than the SIL. Therefore, to achieve the full NA, the layer must have a refractive index comparable to the SIL, or must be thin enough to be fully coupled to the SIL by evanescent waves. The SIL can also be used for extremely high resolution TIRF imaging. Microfluoroscopy used in combination with TIRF has to potential to be a very productive combination.

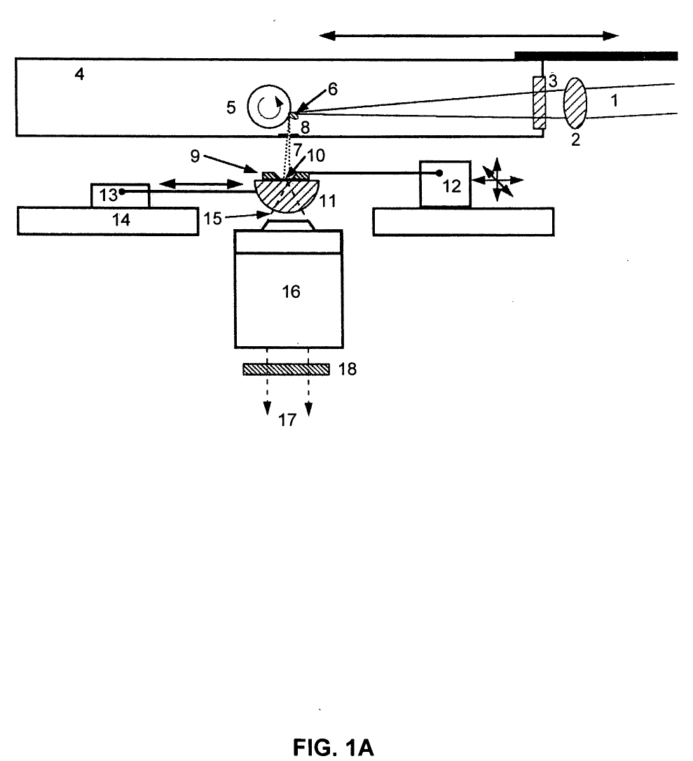

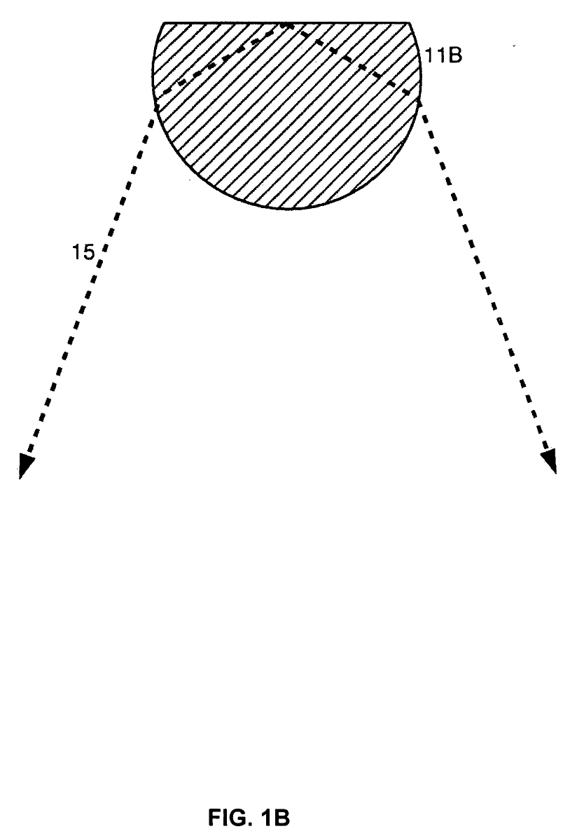

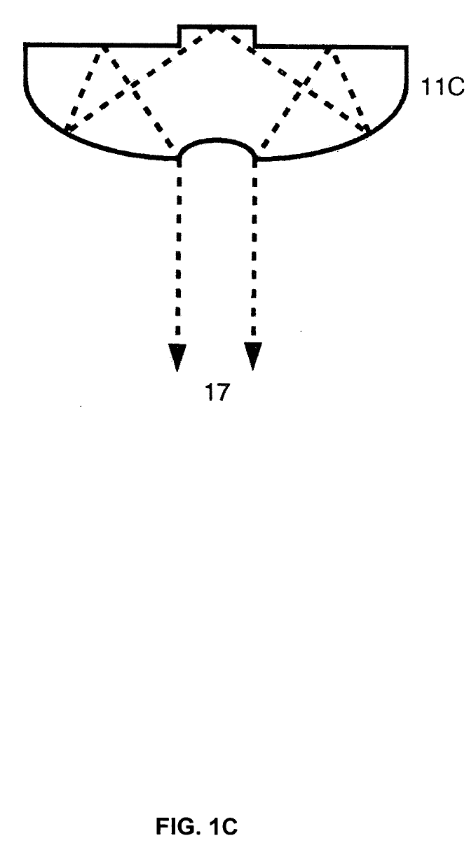

Referring to FIG. 1, an LPM being used in an inverted microscope configuration with a hemispherical SIL is illustrated. While an inverted microscope is very convenient for this instrument, all configurations of light microscopes are possible. A pulsed laser beam 1 passes through a focusing lens 2 and glass window 3, to enter helium-filled target chamber 4. The focused laser beam impinges on a rotating laser target 5. The high power density of the focused laser beam on the target surface creates extremely hot plasma 6, which radiates soft x-rays in all directions. A small aperture 8 forms a collimated beam of soft x-ray 7. This beam impinges on a thin membrane window 9, which is typically composed of silicon nitride with a thickness near 100 nm. The window carries a sample 10, which may be in a dry, wet or frozen state. After passing through the sample, the x-ray contact image is projected onto the surface of the SIL 11. The SIL may be constructed homogeneously from a luminescent material, or it may have a luminescent film on the surface. The sample window is mounted on fine positioning devices 12 to position the region of interest microscope's optical axis. The SIL is positioned on another positioning device 13 to center it to the optical axis. Both of these positioning stages are in turn mounted to the stage 14 of a standard inverted optical microscope. Scintillator light 15 produced at the surface of the SIL by the x-rays travels towards the microscopes objective lens 16. Due to the nearly perfect hemispherical shape of the SIL, the light rays pass through the surface of the SIL with virtually no refraction. The light collected by the objective is then projected towards a distant camera. It is often desirable to include a bandpass filter 17 to exclude all light outside the emission band of the scintillator. Item 17 could also be a polarizing filter. This is necessary if birefringent non-cubic materials are used to fabricate the SIL. Infinity corrected objectives are preferred, but not required.

In addition to the hemispherical SIL, there is also the possibility to use an aplanat SIL; also known as a “Weierstrass optic” or “Supersphere.” This SIL is a truncated sphere with a height of (1+1/n)r, where r is the radius of curvature and n is the index of SIL index of refraction. Referring to FIG. 1B, the optical path in a aplanat SIL 11B is illustrated. It can be seen that the light path 15 is refracted at the SIL surface. Due to this refraction, a lower NA objective lens can be used to collect the full light cone from the SIL. This is desirable since it gets progressively more difficult to build high NA objective lenses with large enough working distances to use a SIL. Hemispherical SIL optics are generally used with a 0.8 NA or greater objectives, which puts constraints on the size of the SIL. A significant disadvantage of this type of optic is that it exhibits large chromatic aberration if highly monochromatic light is not used.

A third variety of SIL uses both refraction and reflection. The most common type is the catadioptric SIL. Referring to FIG. 1C, a catadioptric SIL 11C is illustrated. It can be seen that the light path 17 in this SIL undergoes both reflection and refraction. An advantage of this device is that, in principle, no objective lens is needed. However, due to the refractive part of the SIL, there is significant chromatic aberration, just as with the aplanat SIL. In addition to the catadioptric SIL, several other SIL elements have been devised in which reflection is involved. One potentially usable optic in microfluoroscopy is known as a Hemi-Paraboroidal Solid Immersion Mirror.

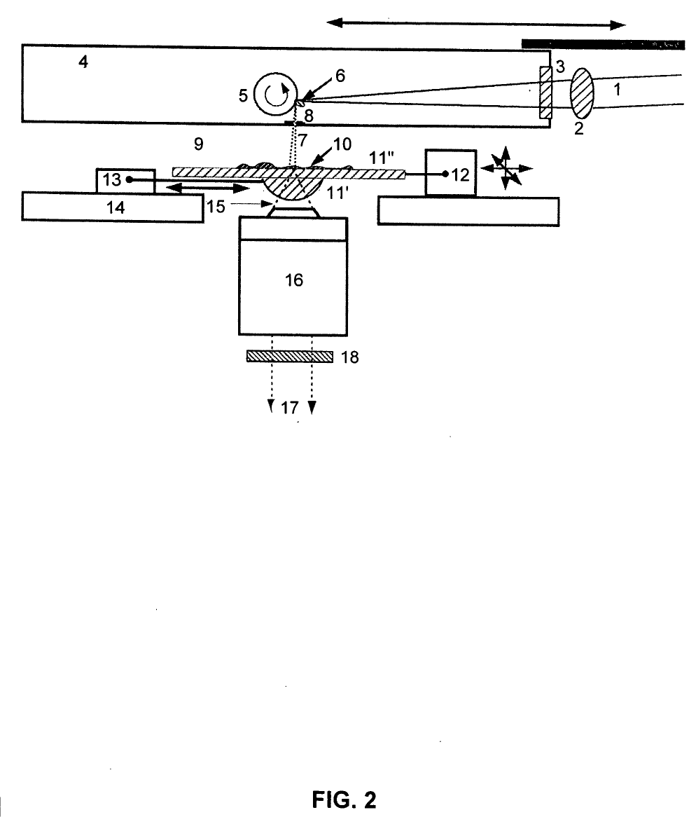

In addition to the single piece SIL, it is possible to construct a hemispherical SIL using two pieces. Referring to FIG. 2, a similar setup to that shown in FIG. 1 is illustrated except that the SIL comprises 2 pieces: 11′ and 11″. In this case, the sample 10 can reside directly onto the top surface of the upper flat piece 11″. The combined thickness of both pieces is made equal to the radius of curvature of the lower convex piece 11′ (in the case of a hemispherical SIL). It is also possible to have an aplanat SIL constructed in two pieces by making the total thickness larger than the radius of curvature. The positioning device 12 is used to slide the upper section of the SIL laterally to position the sample's region of interest to the optical axis. The main technical challenge is keeping any small gap between the two pieces very small. This is to avoid loss of the high-NA rays by total internal reflection at the interface between the two pieces. The gap must be a small fraction of the wavelength for achieving high-NA operation. This problems can be reduced somewhat if a highly refractive liquid fills the gap, instead of air. This increases the angle for total internal reflection off the interface. It also increases the decay length of evanescent waves for rays that exceed the critical angle, thus allowing frustrated internal reflection to occur over longer gap distances.

An important definition regarding the term “plano” that is used throughout this patent when describing the image plane of all types of SIL optics must be clearly stated here. By “plano”, we only imply that the lens surface of the imaged area of the SIL is flat enough to be within the depth-of-field of the imaging system. This still allows the so-called “plano” surface to have a relatively large radius of curvature. Because the depth-of-field in a SIL equipped system is typically well below one micron, the imaged area of the SIL must be close to truly planar, but not absolutely so. Alternately, a significantly non-planar (for instance conical) SIL surface is possible, with a substantially flat area where the image is viewed. The use of a curved or conical surface could actually have some advantage in assuring a sample mounted on a flat thin-window was in intimate contact with the SIL.

High-resolution microfluoroscopy is subject to another possible limitation to resolution in addition to the previously mentioned Fresnel diffraction and Abbe diffraction. This is due to the lateral diffusion of the photo-excited electron-hole pairs before they recombine to generate light. In other words, fluoroscopic light can be created at locations that are a small but finite distance from where the x-ray photons are absorbed. There are several ways to combat this effect. One method increases the number of recombination sites in the crystal lattice by introducing high levels of dopant atoms or other defects. A second method is to put “quantum barriers” into the crystal lattice to confine the diffusion length of carriers. Finally, it would be possible to use electric fields to rapidly drift the carriers to the surface of the scintillator or alternately to a buried junction layer. There, recombination would occur before significant lateral diffusion could take place. It is possible that a p-n junction could be formed on the plano surface of the SIL, and that radiative carrier recombination would occur on the buried junction.

Because there is no refraction at the convex surface of an SIL for rays impinging at normal incidence, there is no image aberration at the direct center of a perfectly made hemispherical lens. However, some aberrations become increasingly apparent as one goes off axis. The most serious is field-curvature aberration. In addition, because the emission spectrum of a scintillator is not extremely narrow, there is also chromatic aberration and chromatic-difference-of-magnification aberration. Analyses of these various aberrations have been made. One finds there is a certain diameter circle that can be considered as aberration free at the center of an SIL. This area is generally large enough for useful imaging. It is possible to design an objective lens to be used with a specific SIL that would correct for these aberrations. This would increase the diameter of the aberration-free viewing area of the SIL to a level comparable to standard objectives.

There is a wide range of potential SIL materials from which to choose. Due to the lack of birefringence, cubic crystals are preferred. There are many synthetic garnets that could be used including the well known scintillators cerium-doped yttrium aluminum garnet (YAG:Ce) and cerium-doped lutetium aluminum garnet (LuAG:Ce). These crystals exhibit strong luminescence in the green spectral range. In addition to cerium doping, other dopants could be used to reduce the emission wavelength in garnet materials. Praseodymium, for instance, can be used to reduce the emission wavelength into the near UV range. However, the index of refraction of garnets is generally below 2.0, which is a bit lower than desirable to take full advantage of a SIL. A somewhat better performance could be realized with the well known scintillator bismuth germanate (BGO). This material has a broad emission peak in the blue range near 480 nm, and a refractive index at that wavelength of 2.15.

An interesting cubic material with a very high refractive index is single-crystal tellurium doped ZnS. This crystal exhibits an intense luminescence peak near 400 nm, with a refractive index of over 2.5 at this wavelength. ZnS would permit a resolution near 100 nm.

Although cubic materials are desirable due to their isotropic optical properties, it is possible to use birefringent crystals, which normally have disturbing overlapping images from the ordinary and extraordinary rays. Fortunately, a polarizing filter can used to remove the distorted extraordinary ray, and image formation is achieved exclusively with the undistorted ordinary ray. One example of a promising hexagonal material is single crystal zinc oxide. This material scintillates strongly at 385 nm and has refractive index near 2.3 at this wavelength. An even higher resolution would be obtained with hexagonal gallium nitride, which is now available in single crystal form. This material exhibits strong luminescence at 365 nm and has a refractive index of approximately 2.7. Gallium nitride is also known to exhibit very short carrier diffusion lengths. Both zinc oxide and gallium nitride used as the SIL would permit a resolution performance of under 100 nm. All of the above are but a few promising examples of highly refractive scintillators that could be employed for use as the SIL in a microfluoroscope.

When deciding on what material to use for the SIL, the “adjusted wavelength” is the crucial number for determining the ultimate resolution limit. Furthermore, if two materials have a similar adjusted wavelength, there are compelling reasons to generally prefer the material having the longer emission wavelength (and higher refractive index). This is because it becomes progressively more difficult and costly to obtain high NA microscope objectives and other microscope components as the wavelength decreases. Very few microscope objectives transmit efficiently below roughly 340 nm. This is also near the wavelength where the quantum efficiency of most CCD cameras is dropping off precipitously. Therefore, this wavelength could be considered a limit for using an LPM with standard off-the-shelf microscope components and CCD cameras.

It is interesting to speculate on how far the SIL technology could be pushed. Deep UV LWD objectives with 0.9 NA have been produced for semiconductor applications. Furthermore, the response of CCD cameras can be extended into the deep UV by coating the chip with a UV-to-visible phosphor. The remaining limitation is to identify the SIL material having the shortest adjusted wavelength. In this respect, diamond may be the ultimate material. Diamond has a bandgap of 5.5 ev, making it transparent down to ≈225 nm. Gem quality single-crystal synthetic diamond is now commercially grown and can be fabricated into lenses. Pure diamond emits intense free-exciton luminescence at a wavelength of ≈235 nm. With a refractive index at this wavelength of ≈2.7, the adjusted wavelength is ≈87 nm. Using a 0.9 NA objective, the theoretical resolution of an instrument using a diamond SIL would be slightly below 50 nm. Heavily boron-doped diamond has been shown to emit a strong room-temperature luminescence peak at 248 nm. This could have an advantage over free-exciton luminescence due to the very small carrier diffusion length of heavily doped materials.

Stereoscopic or tomographic methods may be used with a SIL-equipped microfluoroscope for acquiring 3-dimensional information. In this case, multiple angle images are collected. For stereoscopic imaging, this is most easily achieved by tilting the incidence angle of the x-ray beam. For tomography, a sample can be placed in a rotating micropipette, instead of on a flat window.

All of the above resolution estimates are based on the Abbe formula. It has been demonstrated that computerized deconvolution (image restoration) algorithms can improve on this figure somewhat. The fact that microfluoroscopic images are purely 2-dimensional makes the use of such computer processing easier than when performed complex 3-dimensional objects. This is a further advantage of microfluoroscopy.

Microflouroscope with Nanochannel Masks

The SIL operates within standard diffraction limitations and achieves its high resolution by what could be simply termed brute force. The second method now discussed circumvents the normal diffraction limitations. The idea is very simple in principle. An opaque mask is produced that is perforated with a uniform array of extremely small channels. The diameter of these channels may be only a few tens of nanometers, with a channel spacing of a few hundred nanometers. This “nanochannel mask” is located on the scintillator surface, just behind the sample. The effect of the mask is to limit x-ray excitation on the scintillator to only those areas that are aligned with the channels. By extension, only x-rays transmitted through areas of the sample that are also aligned with the channels are detected. Therefore, the sample's imaged area is limited to a periodic grid of nanometer scale spots. At initial glance, this idea looks somewhat like a near-field microscopy scheme using an array of extremely small suboptical photon collectors. However, this is not a near-field scheme since the nanochannels are significantly larger than the x-ray wavelengths. The channels are spaced widely enough so that the microscope optics can clearly resolve each channel as a separate spot of light in the far field.

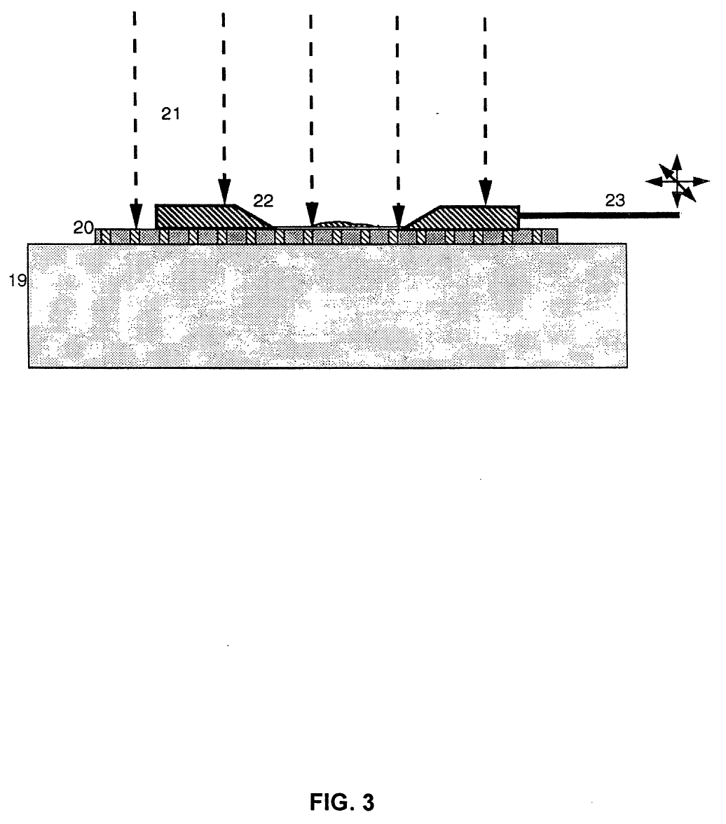

Referring to FIG. 3, the scanning approach to high-resolution microfluoroscopy is illustrated. In this case, the scintillator 19 is in the form of a flat piece, although the use of a SIL is possible and will be mentioned below. The sample is mounted on a thin window. The window is attached to the arm 23 of a very high precision scanning device. Collimated x-rays 21 are made incident on the window/sample. A nanochannel mask 20 is located on the surface of the scintillator, below the sample. To produce a high-resolution absorption image of the entire sample, a series of images are collected while the sample is scanned over the masked scintillator. Different mask and scanning arrangements are possible, which will be described below. The final image is produced in a two-step process. First, the integrated scintillator light-output from each separate channel is determined on each frame and assigned to a single pixel at the location of the channel. Then, the final composite image is digitally created by summing all the frames; with their positions slightly shifted to the correct scan location.

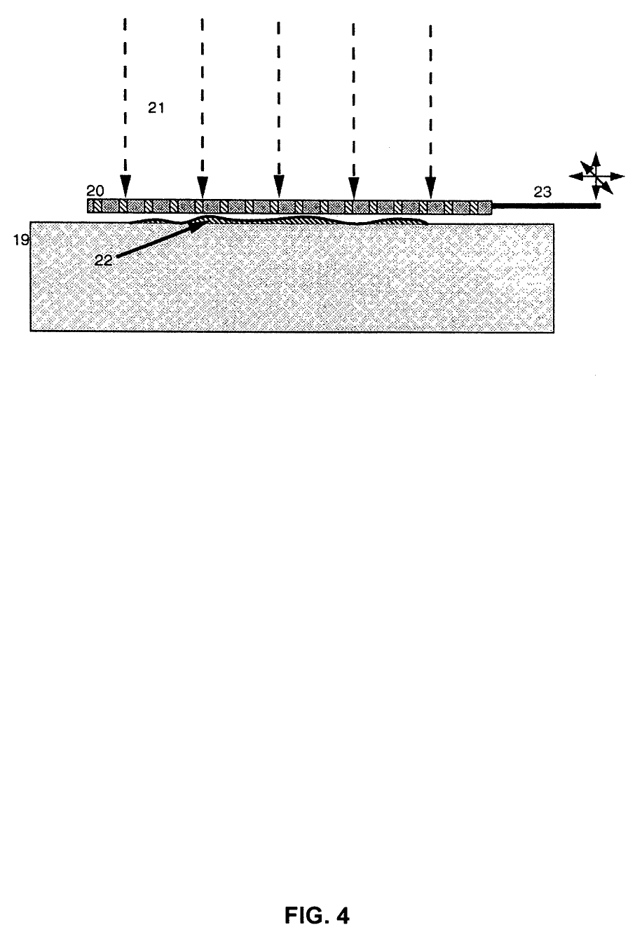

One disadvantage of the scanning approach as just described is that the whole sample is continually exposed to radiation during the imaging process. An alternative geometry that greatly reduces radiation exposure is to place the mask directly before the sample. In this case, only areas that are inline with the channels receive radiation. Referring to FIG. 4, the nanochannel mask is positioned above the sample 22, which may be attached directly onto the scintillator in this configuration. The nanochannel mask is scanned, in the same manner as the sample was in FIG. 3.

Several conceivable methods could be used to produce the masks with advanced electron beam or ion beam lithography equipment that is used in the semiconductor industry. However, one of the challenges is to produce the masks very inexpensively, since they may be damaged in use and require periodic replacement. This appears to rule out direct-write lithography methods. Fortunately, a procedure that appears well suited to inexpensively producing the masks has been identified. This method uses technology that was developed to manufacture microchannel plate (MCP) image intensifiers. The MCP is a polished glass wafer that is penetrated by a uniform array of tiny channels. The channels can be arranged in either a hexagonal-close-packed or a square lattice. Other channel-spacing configurations are possible such as rectangular, but square and hexagonal lattices are the most practical. MCP channel diameters vary, but are typically ≈10 μm. It has been found possible to extend this technology to create over 10¹¹ channels/cm² with diameters below 20 nm. This material is termed “nanochannel glass” and is the basis for producing our masks.

There are two possible approaches to making the nanochannel mask using nanochannel-glass material. The first is to manufacture nanochannel glass membranes having the desired channel diameter and spacing. The difficulty here is that the aspect ratio of the channels (L/D) is generally limited to several hundred. Thus, the glass material would have to be polished to an impractically thin layer. A second and more practical approach is to deposit a metal film on the surface of a thick wafer of nanochannel glass that has shallow etched channels just on the surface. The metal film is stripped off to produce a thin freestanding mask, with holes that replicate the glass surface. In this second approach, it is also possible to reduce the channel size in a controlled manner by carefully monitoring the amount of metal deposited. As the film is built up, the channel openings are closed down. Due to the metal's high attenuation for soft x-rays, only a thin metal layer is needed to produce an opaque mask

Scanning is typically accomplished using piezoelectric actuators, which are conveniently used with a flexure stage. These nanopositioning stages can be run with either open loop or closed-loop feedback control of position. Closed-loop stages are remarkably precise, and often have sub-nanometer positional reproducibility. Open-loop stages are less reproducible, with typical accuracies of 20-50 nm. The advantage of open loop systems is lower complexity and cost.

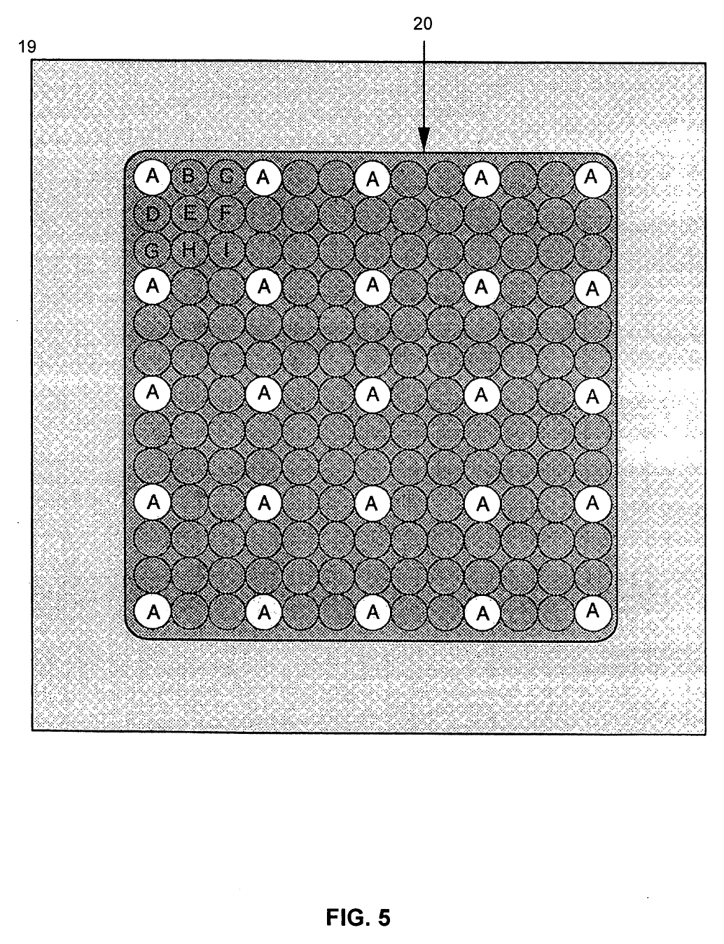

We now describe several possible mask patterns and scanning sequences that can be used. In the following four figures, it should be understood that an actual nanochannel mask may have over one million separate channels. The very small number of channels shown in these figures represents only a tiny section of a real mask, and is for conceptualization purposes only. The first example is a square channel-pattern and an X-Y scanning sequence. Although it is possible to form channels in a rectangular configuration, we will consider only the symmetrical square array here. Referring to FIG. 5, a mask 20 is shown positioned over a scintillator 19. In this example, the channels in the mask are located at the positions labeled A. They are spaced on a grid with a separation of approximately 3 times the channel diameter. During image acquisition, the sample (or mask) is raster scanned over the scintillator in a sequence that moves the channel position A to nine different locations in the order: A-B-C-D-E-F-G-H-I. Generally, the step motion is a full channel diameter, but it would be possible to move less than this for each image, and deconvolution techniques used to get even higher resolution. By collecting images at these nine separate positions, the whole sample area is imaged.

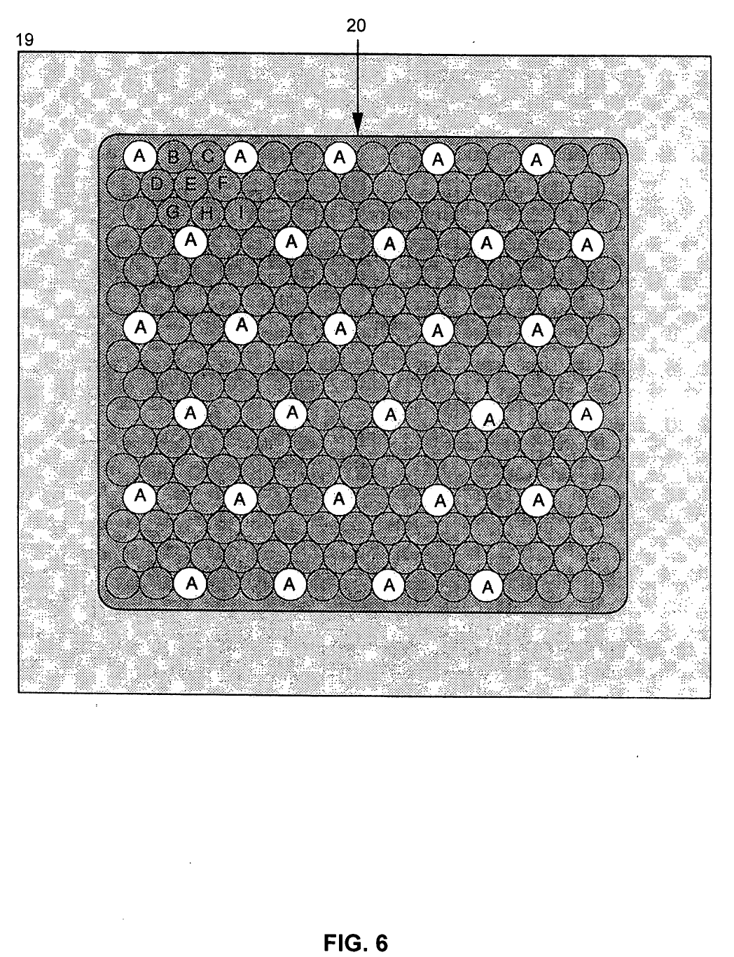

Referring to FIG. 6, a hexagonal mask is shown. As with the square array of FIG. 5, image acquisition is accomplished by scanning the sample (or mask), and collecting nine corresponding images. The only difference here is that the motion in now not in a rectilinear grid pattern. This makes the scanning and final image synthesis slightly more difficult. However, hexagonal arrays of holes are slightly easier to manufacture than square ones.

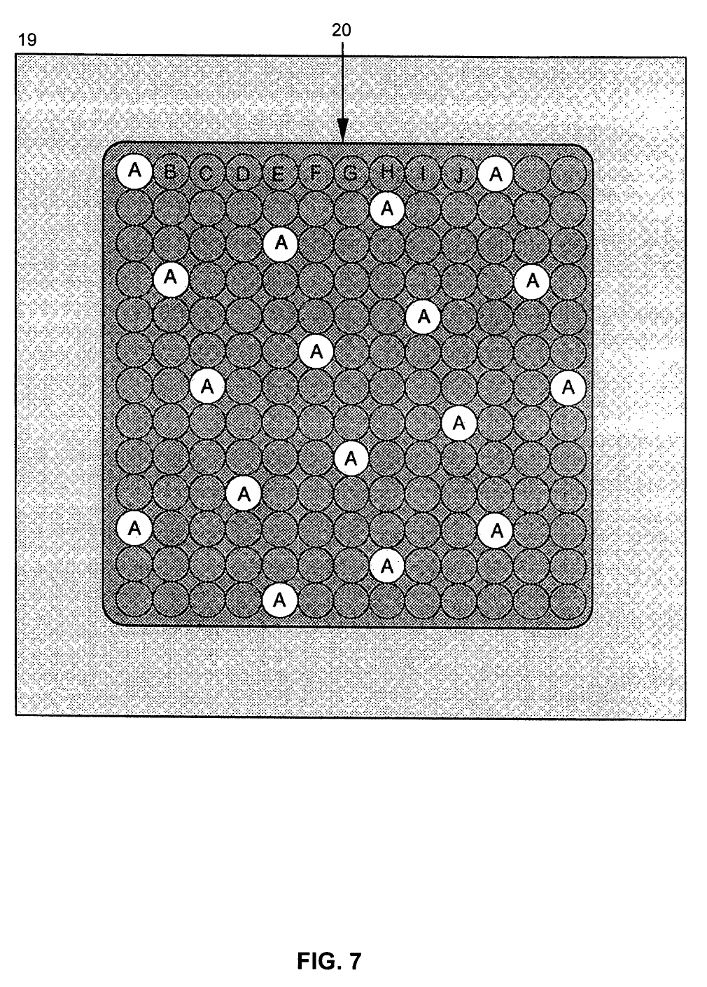

Referring to FIG. 7, a square array of channels is again illustrated. However, in this case, the X-Y plane of the mask is tilted, and scanning is only done along the X-axis. By moving the channel linearly in the sequence A-B-C-D-E-F-G-H-I-J, the whole sample may be imaged while using only a single-axis nanopositioning stage. This simplifies the experimental hardware, and removes potential hysteresis issues that can occur in open-loop piezoelectric motion systems when scanning in a raster. This is somewhat analogous with backlash that occurs in mechanical systems.

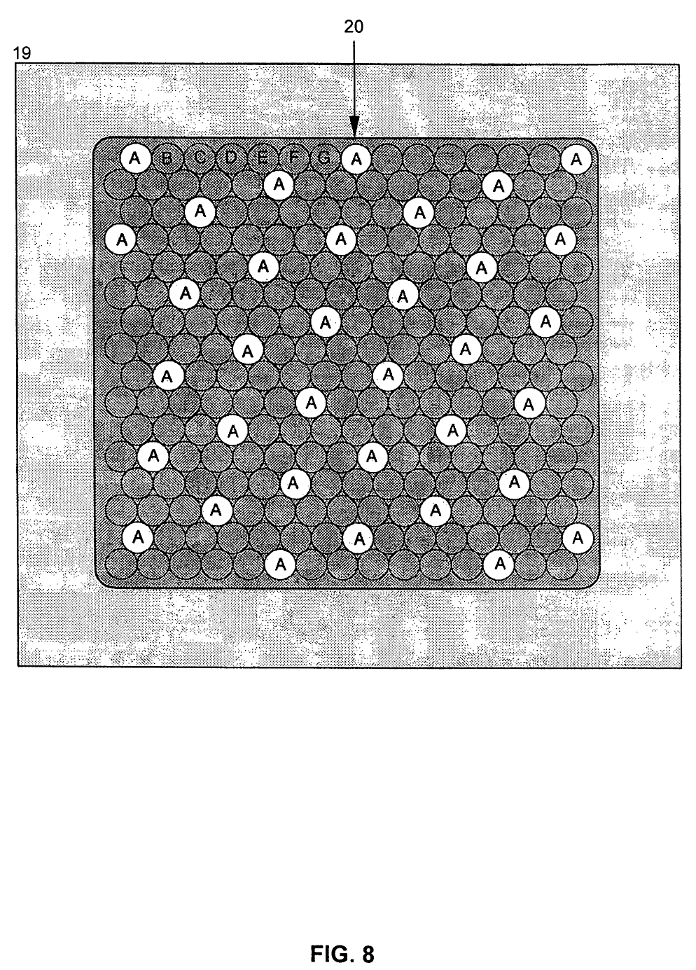

Referring to FIG. 8, the corresponding hexagonal version of single-axis scanning is illustrated. Here the hexagonal pattern of channels A, is tilted in the X-Y plane. Scanning is accomplished by moving the sample (or mask) in the X-axis in the sequence A-B-C-D-E-F-G.

Comparison between SIL and Nanochannel Mask

The two methods just described for achieving high resolution have certain relative merits. The SIL approach is certainly a much easier system to implement, since no precision scanning and image reconstruction steps are necessary. One simply moves the sample's region of interest to the center of the SIL and collects a single image. The lack of a scanning system makes the instrument less complex and costly. Image acquisition is also faster. The only comparative disadvantage of the SIL is the diffraction limitations. Conversely, the advantage of the scanning approach is that the ultimate resolution could be significantly higher. The great advantage of the scanning approach is that resolution is determined solely by the channel size (assuming accurate scanning, and neglecting Fresnel diffraction. Although the diffraction limit of the optics used to view the scintillator light from each nanochannel does not directly correlate with achieved resolution, it is central in determining how close together channels can be packed and still be individually resolved. This, in turn, determines how many separate raster points need to be recorded to collect a full image. Consequently, the best approach may be to use both of these devices in combination. Scanning would then be used to achieve maximum resolution, with the SIL concurrently permitting fewer raster steps.

Cryo-Microfluoroscopy

Cryogenic methods are a practical means to reduce radiation damage effects, and it permits the use of a smaller and less costly laser. Due to the relatively long image acquisition time involved with the scanning approach, the use of frozen or freeze-dried samples is probably mandatory. This is also an issue with 3-dimensional imaging, which requires multiple views.

Freeze drying is one method of drying biological samples with a minimum of artifacts. An alternate to using a dedicated freeze-dryer is to use a cryostage mounted directly on the microscope stage. There have been a number of previous examples of cryostages designed for light microscopes, which would be usable with microfluoroscopy. This stage could also be used for imaging frozen-hydrated samples. Frozen-hydrated samples are less prone to having artifacts than freeze dried samples, since the sample's components are rigidly held in an ice matrix. Samples are structurally indistinguishable from the living state if cryofixation is done correctly. However, maintaining a sample in the frozen-hydrated state is more difficult than imaging dry samples. It is possible that the best results will be achieved with samples that are partially freeze-dried, instead of being completely imbedded in an ice layer. This would give superior contrast and higher x-ray transmission. Being able to perform partial or complete freeze-drying on the microscope stage has the advantage of allowing the drying progress to be monitored using the microscope's optics. It also means a separate freeze-dryer is not needed, and that samples can remain at the desired low temperature during both drying and imaging.

The SIL offers an elegant solution to using a microfluoroscope with a cryostage. At low temperatures, oil immersion objective are not practical due to freezing of the liquid. However, it would be possible to design an instrument with an SIL held at the same low temperature as the sample. The dry objective would then view the cold SIL through a thin window. Concerning low-temperature scintillator use, there is generally a desirable increase in light output as temperature is reduced in most scintillator crystals. Of course, the use of a cryostage is also quite possible for the nanochannel-mask imaging embodiments.

1. A microfluoroscope comprising:
a source of soft x-rays;
a solid immersion lens including a plano surface;
means for placing a sample in close proximity to the plano surface so that an x-ray absorption shadowgraph of the sample is projected onto the plano surface by the source of soft x-rays;
a scintillator on the solid immersion lens plano surface for producing fluorescent light from soft x-rays passing through the sample; and,
an optical microscope for viewing through the surface of the solid immersion lens the fluorescent light from the scintillator corresponding to the x-ray absorption shadowgraph of the sample.

2. The microfluoroscope of claim 1 and wherein:
the solid immersion lens includes a plano-convex hemispherical lens having a a hemispherical refractive surface with a center of curvature on the plane surface.

3. The microfluoroscope of claim 1 and wherein:
the solid immersion lens includes an aplanat solid-immersion-lens.

4. The microfluoroscope of claim 1 and wherein:
the solid immersion lens includes a catadioptric solid-immersion-lens.

5. The microfluoroscope of claim 1 and wherein:
the source of soft x-rays is a hot plasma.

6. The microfluoroscope of claim 1 and wherein:
the solid immersion lens includes the scintillator.

7. The microfluoroscope of claim 6 and wherein:
the scintillator is within the solid immersion lens material.

8. The microfluoroscope of claim 6 and wherein:
the scintillator is a thin film on the solid immersion lens surface.

9. The microfluoroscope of claim 1 and wherein:
the solid immersion lens is constructed from diamond.

10. The microfluoroscope of claim 1 and wherein:
the solid immersion lens has the shape of an aplanat optic.

11. The microfluoroscope of claim 1 and wherein:
the solid immersion lens has at least one reflecting surface.

12. The microfluoroscope of claim 1 and wherein:
the solid immersion lens is composed of a birefringent material and a polarizing filter is used to selectively removed one polarization component of the image.

13. The microfluoroscope of claim 1 and wherein:
the optical microscope for viewing through the solid immersion lens corrects optical aberrations caused by the solid immersion lens.

14. The microfluoroscope of claim 1 and wherein:
means for holding the solid immersion lens at low-temperature.

15. The microfluoroscope of claim 1 and wherein:
means for holding the sample at low-temperature.

16. The microfluoroscope of claim 1 and wherein:
the solid immersion lens includes two pieces that can be laterally moved with respect to one another.

17. The microfluoroscope of claim 16 and wherein:
a liquid is placed in the gap between the two pieces that can be laterally moved with respect to one another.

18. A microfluoroscope comprising:
a source of soft x-rays;
a fluorescent screen placed at a plane to receive x-rays;
means for placing a sample in close proximity to the plane so that an x-ray absorption shadowgraph of the sample is projected onto the fluorescent screen;
a nanochannel mask placed between the flourescent screen and the sample for limiting x-rays reaching the fluorescent screen to a periodic matrix of nanochanneled beams;
means to raster scan the sample over the nanochannel mask;
an optical microscope for viewing the fluorescent light emitted by the fluorescent screen that corresponds to the locations of the nanochanneled beams;
a camera to collect the fluorescent image of the nanochanneled beams impinging on the fluorescent screen at each raster location as discrete images; and,
a computer system to combine all the discrete images at each raster position into a composite image representing the x-ray absorption shadowgraph of the entire sample.

19. The microfluoroscope of claim 18 wherein:
the nanochannel mask is constructed using nanochannel glass.

20. The microfluoroscope of claim 18 wherein:
the nanochannel mask is a membrane constructed by replication of nanochannel glass.

21. The microfluoroscope of claim 18 wherein:
the fluorescent screen is the plano surface of a solid immersion lens.

22. A microfluoroscope comprising:
a source of soft x-rays;
a fluorescent screen placed at a plane to receive x-rays;
means for placing a sample in close proximity to the plane so that an x-ray absorption shadowgraph of the sample is projected onto the fluorescent screen;
a nanochannel mask placed between the sample and the source of soft x-rays for projecting a matrix of nanochannelled beams of soft x-rays through the sample and onto the fluorescent screen;
means to raster scan the nanochannel mask over the sample;
an optical microscope for viewing fluorescent light emitted by the fluorescent screen that corresponds to the locations of the nanochanneled beams;
a camera to collect the fluorescent image of the nanochanneled beams impinging on the fluorescent screen at each raster location as discrete images; and,
a computer system to combine all the discrete images at each raster position into a composite image representing the x-ray absorption shadowgraph of the entire sample.

23. A process of microfluoroscopy comprising the steps of:
providing a source of soft x-rays;
providing a solid immersion lens including a plano surface;
placing a sample in close proximity to the plano surface so that an x-ray shadowgraph of the sample is projected into the solid immersion lens;
providing a scintillator on the solid immersion lens for producing fluorescent light from soft x-rays passing through the sample;
providing an optical microscope; and,
viewing fluorescent light emitted by the scintillator through the surface of the solid immersion lens with a microscope to observe the x-ray absorption shadowgraph of the sample.

24. The process of microfluoroscopy of claim 23 and comprising the further steps of:
providing a nanochannel mask in close proximity to the plano surface of the solid immersion lens;
scanning the sample over the nanochannel mask and scintillator to image only x-rays passing through the sample to the fluorescent screen and solid immersion lens in locations corresponding to the nanochannel mask openings.

25. A process of microfluoroscopy comprising the steps of:
providing a source x-rays;
providing a fluorescent screen placed at a distant plane to receive radiation;
placing a sample in close proximity to the distant plane so that an x-ray absorption shadow of the sample is projected onto the fluorescent screen;
providing a nanochannel mask placed between the fluorescent screen and the sample for limiting x-rays reaching the fluorescent screen to a periodic matrix of nanochannelled beams;
providing means to raster scan the sample over the nanochannel mask;
providing an optical microscope for viewing fluorescent light emitted by the fluorescent screen corresponding to the locations of the nanochannelled beams;
providing a camera to collect the fluorescent image of the nanochannelled beams impinging on the fluorescent screen at each raster location as discrete images; and,
providing a computer system to combine all the discrete images at each raster position into a composite image representing the x-ray absorption shadowgraph of the entire sample.
